(19) United States
(12) Patent Application Publication
(10) Pub. No.: US 2006/0279058 A1
(43) Pub. Date: Dec. 14, 2006

(54) Knee-racer ride-on vehicle

(75) Inventors: Gregory Padginton, Thousand Oaks, CA (US); Nathan Proch, Los Angeles, CA (US)

Correspondence Address: ALLEMAN HALL MCCOY RUSSELL & TUTTLE LLP, 806 SW BROADWAY, SUITE 600, PORTLAND, OR, 97205-3335, US

(73) Assignee: Mattel, Inc.

(21) Appl. No.: 11/295,184

(22) Filed: Dec. 5, 2005

Related U.S. Application Data
(60) Provisional application No. 60/684,615, filed on May 24, 2005.

(51) Int. Cl. B62M 1/08

(52) U.S. Cl. 280/251

(57) ABSTRACT

A vehicle ridden by a rider having feet and knees, comprising: a chassis having at least one wheel, where said chassis is configured to receive at least one knee and at least one foot of the rider in a manner that permits the rider to be in a kneeling position when operating the vehicle.

### CROSS-REFERENCE TO RELATED APPLICATIONS

This present application claims priority to U.S. Provisional Patent Application Ser. No. 60/684,615, filed on May 24, 2005 which is hereby incorporated by reference in its entirety for all purposes.

### BACKGROUND AND SUMMARY

There are various types of ride-on vehicles and toys. One approach is U.S. Pat. No. 6,170,596 which shows a four wheel go-cart where the rider is configured in a seated position where the arms and legs are extended forward the vehicle controls. The inventors herein have recognized disadvantages with such an approach. For example, the go-cart simulates a vehicle, such as a car, and therefore the similar body positioning and vehicle control is apt to be monotonous. Further, when configured in a seated position, the rider may perceive the vehicle speed to be slow, and the operator's field of vision may be obstructed by the vehicle.

Another ride-on product is U.S. Pat. No. 4,678,444, which shows a knee board utilized on a water surface. While providing an alternative riding configuration and rider position, the knee board may provide the rider with a higher perceived speed compared to vehicles having a seated rider position under some conditions. However, the inventor herein has also recognized a disadvantage with knee boards in that they are confined to water.

In one approach, the above issues may be addressed by a vehicle ridden by a rider having feet and knees, comprising a chassis having at least one wheel, where said chassis is configured to receive at least one knee and at least one foot of the rider in a manner that permits the rider to be in a kneeling position when operating the vehicle.

### DESCRIPTION OF FIGURES

FIG. 1 is a two-dimensional schematic side view of an example embodiment of the knee racer vehicle.

FIG. 2 is a three-dimensional isometric view of an example embodiment of the knee racer vehicle.

FIG. 3 is a three-dimensional isometric view of an example embodiment of the knee racer vehicle with the rear cover removed.

FIG. 4 is a three-dimensional isometric view of an example embodiment of the knee racer vehicle with the front knee supports removed.

FIG. 5 is a two-dimensional schematic view of an example embodiment of the vehicle propulsion system.

FIG. 6 is a two-dimensional schematic top view of an example embodiment of the front section of the knee racer vehicle.

FIG. 7 is a three-dimension isometric view of an example embodiment of the knee racer vehicle.

### DETAILED DESCRIPTION

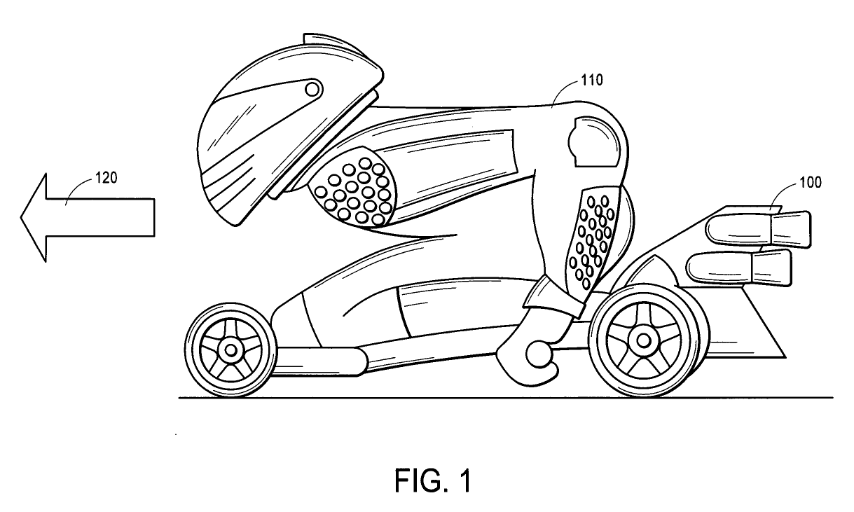

The present application relates to a vehicle ridden by a rider. In one example, the vehicle can be a powered vehicle ridden by the user for fun and excitement. In another example, the vehicle can be powered by the rider, or alternatively be passive. FIG. 1 shows a two-dimensional schematic view of a vehicle 100 operated by rider 110. As described herein, the vehicle may be ridden where the rider is in a kneeling position.

In particular, with reference to FIG. 1, rider 110 may be situated on vehicle 100 in a manner where the lower legs of the rider are folded under the upper legs. Rider 110 may be further secured to vehicle 100 by grasping a handle bar located between the front and rear wheels of the vehicle. FIG. 1 shows vehicle 100 traveling forward in a direction denoted by arrow 120. In this manner, rider 110 may be able to ride on vehicle 100 while in a kneeling position. Although FIG. 1 shows with the rider 110 bending forward with their upper body substantially over their knees, in other configurations, the upper body of the rider may be substantially upright or reclined. Vehicle 100 while shown herein as a “street vehicle” may otherwise be used on a variety of other terrains such as off road or mountain terrain. As such, various versions of the knee racer vehicle are contemplated herein, where different versions may be tailored to different terrains via modified wheels, gear ratios, motors, etc.

As will be described in more detail below, vehicle 100 may have formed sections to accommodate the rider's legs and feet in order to facilitate the kneeling position. The body positioning of the rider during operation of vehicle 100 creates an exciting ride by encouraging a lower center of mass, thus giving the rider the perception of traveling at a high speed. Further, vehicle 100 provides a unique riding arrangement that may be less monotonous than a passive seated position.

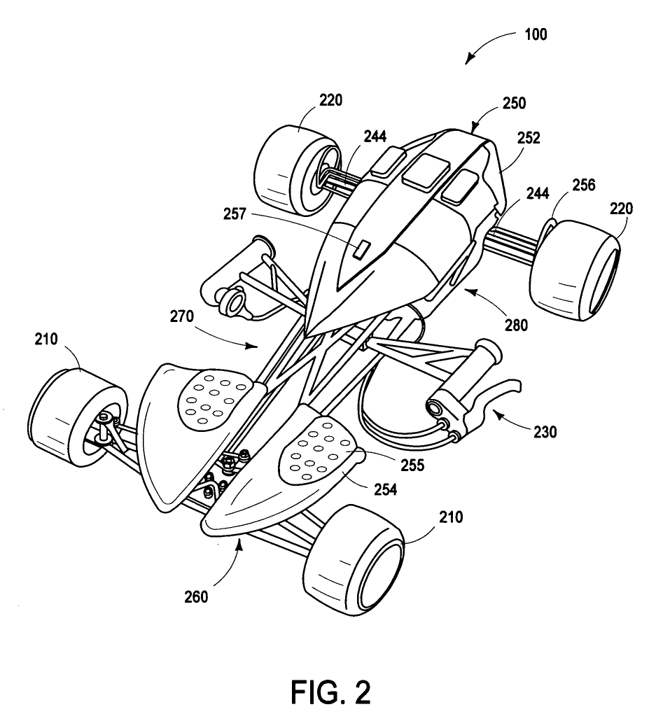

Referring now to FIG. 2, a three dimensional isometric view of an example embodiment of vehicle 100 is shown without rider 102. FIG. 2 shows vehicle 100 with two front wheels 210 and two rear wheels 220. FIG. 2 also shows vehicle 100 with main section 250, which in some embodiments may be comprised of a front chassis 260, a center chassis 270 and a rear chassis 280. Front wheels 210 and rear wheels 220 may be coupled to main section 250 by axles 242 (not shown) and 244 respectively. A handle bar 230 is shown in FIG. 2 coupled to center chassis 270 for controlling vehicle 100. A further discussion of the various components of vehicle 100 is provided below.

Note that FIGS. 1-7 are approximately to scale. Vehicle 100 shown herein is approximately 36 inches in length, 20 inches in width and 8 inches in height, however various other size and/or shapes are possible. In some embodiments, the size and shape of the vehicle may correlate to the size and shape of the rider, while in other embodiments, the weight of the vehicle may be proportional to the desired performance of the vehicle. For example, a vehicle configured for a rider of relatively small size, shape and/or weight (such as a child) may likewise be of a proportionally smaller size, shape and weight. Thus, in some examples, a vehicle configured to be operated by a small rider may weight between 20 pounds and 40 pounds, while a vehicle configured for a large adult may have a vehicle weight between 40 pounds and 60 pounds. Thus, in some embodiments, as the vehicle size and weight may generally correspond to the size and weight of the rider. In such embodiments, the vehicle may be easily carried by the rider of the specific vehicle.

Continuing with FIG. 2, the two front wheels 210 and the two rear wheels 220 of vehicle 100 are shown. Wheels 210 and 220 may be comprised of a metal interior hub with an outer rubber section as shown in FIG. 2, where a hole through the center of the interior hub may used to attach the wheel to a shaft or axle. In some examples, wheels 210 and 220 may comprise a variety of materials or combinations of materials such as metal, plastic and/or rubber among various others. In some embodiments, rear wheels 220 may be of a larger diameter and/or width than front wheel 210. Further, the outer portion of wheels 210 and 220 may comprise tires that are smooth, treaded or combinations thereof. In some examples, wheels 210 and 220 and/or tires may be easily removed to facilitate exchanging wheels/tires for those specific to a desired terrain condition such, as street, off road or mountain, among others. Further, wheels 210 and 220 may comprise portions that are translucent, transparent or combinations thereof. In yet another example, wheels 210 and 220 may be configured with a plurality of colored portions among various other aesthetic arrangements. In some embodiments, vehicle 100 may utilize greater than four wheels, while in another embodiment, less than four wheels and may used, for example, a tricycle configuration.

Continuing with FIG. 2, rear wheels 220 are shown attached to rear chassis 180 of center section 250 by a single rear axle 244. Rear axle 244 is shown in FIG. 2 comprising a solid round metal shaft. In another embodiment, rear axle 244 may comprise two individual rear axles, one for each wheel. In yet another embodiment, rear axle 244 may comprise a plurality of axles.

Front wheels 210 are attached to front chassis 260 by separate front axles 242 (not shown). In this manner, front wheels 210 may be permitted to turn relative to each other and front chassis 260. Thus, in such embodiments, the vehicle may be referred to as having a front wheel steer configuration. In other embodiments, front axle 242 may comprise a single axle shared by both wheels.

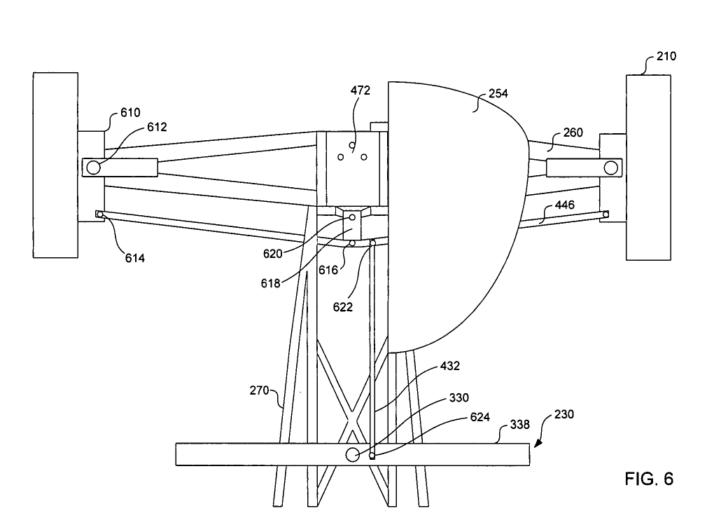

In other embodiments, front wheels 242 may be set in a fixed configuration with a single axle while rear wheels 220 are connected to center section 250 in a manner that permits the turning of rear wheels 220 relative to vehicle 100. Thus, in such embodiments, the vehicle may be referred to as having a rear wheel steer configuration. In other embodiments, the vehicle may use a four wheel steer configuration where both front and rear wheels are able to turn relative to the vehicle. In yet other embodiments, both front wheels and rear wheels may be in a fixed configuration relative to center section 250. In this manner, the rider may utilize body positioning such as leaning in order to steer the vehicle. Vehicle control will be discussed in more detail below with reference to FIG. 6.

Continuing with FIG. 2, vehicle 100 may include a center section 250 that comprises a plurality of chassis portions. A single chassis or plurality of chassis may be utilized in this manner to support various vehicle components. As shown in FIG. 2, center section 250 may include a rear chassis 280, a center chassis 270, and a front chassis 260. The multiple chassis portions may be removably coupled and thus secured by a bolted interface among a variety of other methods. In other embodiments, the chassis portions may be permanently coupled by welds or other method. In some embodiments, the multiple chassis portions may be further configured in a manner that allows for quick assembly/disassembly of the vehicle.

Further, the various chassis portions may be configured in a manner that allows customization of portions of the vehicle for performance and/or aesthetic purposes. For example, an interchangeable rear chassis portion may be used accommodate specific rider age groups or specific riding terrain among others.

Chassis sections 260, 270 and 280 are shown in FIG. 2 as comprising hollow round steel tubing welded into the three separate chassis portions. In some embodiments, the chassis may comprise a mixture of solid and/or hollow tubing. In some embodiments, box tubing or various other combinations of structural elements may be configured to create a central chassis structure. Alternatively, the chassis sections may include various other materials such as metal, carbon-fiber or plastic among others.

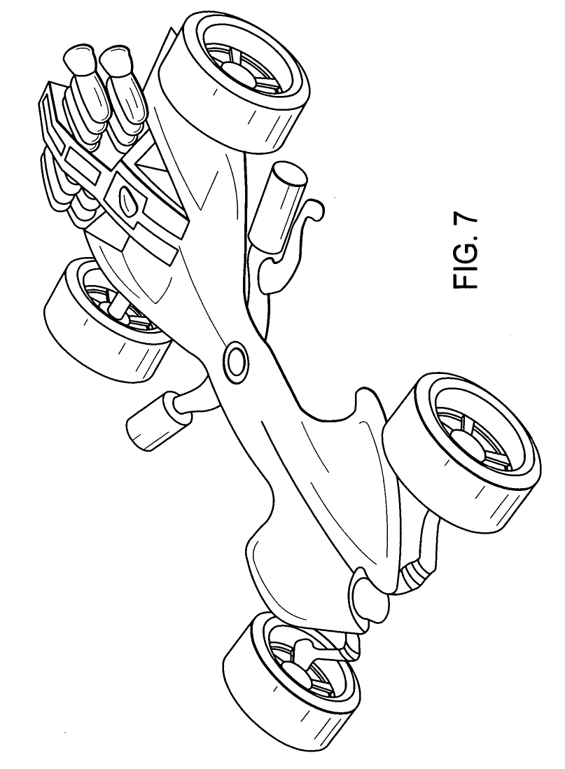

In some embodiments, vehicle 100 may comprise a chassis formed from a single section (as shown in FIG. 7). In this configuration, the single chassis section may serve as both chassis and/or various vehicle components such as knee supports, foot supports, and handles among others. In yet another embodiment, multiple chassis may be configured one on top of the other in a manner that provides improved suspension, vehicle control, vehicle stability, and/or vehicle strength among others. A further discussion of an example vehicle suspension is provided below.

Continuing with FIG. 2, a rear cover 252 is shown separating propulsion system 350 (not shown) from the rider or various other foreign objects. In the example shown in FIG. 2, the rear cover is located behind the rider thus not restricting vision or movement of the rider. FIG. 2 shows rear cover 252 as a low profile convex covering coupled to rear chassis 280. A front tapered portion of rear cover 252 is shown extending over a portion of center chassis 270. Rear cover 252 is shown comprising a formed metal shell having a plurality of small openings or holes. Further, these openings may be utilized for ventilation of the vehicle propulsion system and/or aesthetic purposes among others.

In other embodiments, rear cover 252 may comprise a plurality of shapes and sizes utilized for both functional and aesthetic purposes. For example, rear cover 252 may contain a decorative raised portion that simulates a large internal combustion engine or jet engine with afterburner sections. In yet another example, rear cover 252 may serve to better accommodate the rider such as providing a back rest or seated portion. Further, rear cover 252 may be integrated into other vehicle components such as the rear chassis, knee supports, foot supports, etc. to form a single combined section. In some embodiments, rear cover 252 may comprise a variety of alternative materials such as plastic, metal, rubber, carbon-fiber or combination thereof. In yet another example, rear cover 252 may contain a door or port for accessing the various components located within the rear cover.

Further, FIG. 2 shows a 2 position toggle switch 257 located on rear cover 252. Switch 257 may be used to turn on/off the vehicle propulsion system. Alternatively, switch 270 may be located under rear cover 252, on handle bar 230, or among various other vehicle components. In some configurations switch 257 may perform a plurality of vehicle control operations and/or comprise a plurality of control switches.

Continuing with FIG. 2, two knee supports 254 located in the front of vehicle 100 are shown coupled to center chassis 270 between front wheels 210. FIG. 2 shows knee support 254 as a concave section comprising a thin porous metal mesh. Knee support 254 is shown shaped as a long basket with a tapered front portion and open rear portion configured to accept and cradle the knee of the rider during vehicle operation.

In some embodiments, knee support 254 may include a separate padded surface 255 for improved rider comfort and safety. Padded surface 255 may be integrated into knee support 254 as a single combined section or alternatively configured as a separate removable padded portion as shown in FIG. 2. In some examples, padded surface 255 may occupy only a portion of knee support 254 or the entire support surface. Padded surface 255 may comprise materials such as rubber, high density closed cell foam, plastic or various other materials. Further, the surface features of padded surface 255 may comprise raised and/or depressed portions that may further secure the knee of the rider against translation during vehicle operation. In some embodiments, knee support 254 may utilize straps to further secure the rider to vehicle 100.

Knee support 254 may be utilized for a variety of reasons such as to improve rider comfort over a sustained period of use, to distribute the rider's weight over an increased area and/or to protect the rider from various vehicle components or moving terrain among others. The concave configuration of knee pad 254 may provide a means of orienting the knee of the rider for improved riding comfort and/or safety white simultaneously accepting a substantially broad range of rider knee shapes and sizes. In this manner, the rider may be configured in a position where the lower legs are folded under the upper legs in a kneeling manner.

Alternatively, knee support 254 may form a substantial depression that further constrains knee motion relative to the vehicle. In yet another embodiment, knee support 254 may comprise a substantially flat surface portion without substantial depression. In some examples, the two individual knee supports 254 shown in FIG. 2 may be configured as a single portion. Alternatively, knee support 254 may be integrated into a portion or portions of the vehicle chassis. In this manner, the knee supports and chassis sections may comprise a single section as shown below with reference to FIG. 7. Further knee support 254 may comprise various other materials such as metal, plastic, rubber, high density foam, cloth, carbon-fiber or combinations thereof.

In some embodiments, vehicle 100 may include a foot support 256 located near the rear of vehicle 100 as shown in FIG. 2. FIG. 2 shows foot support 256 as a plurality of metal structural supports surrounding axle 260 and a vertical component which provides separation between the rider's foot and rear wheel 220. Similar to knee support 254, foot support 256 may be configured in a manner that cradles the foot and/or lower leg of the rider. In particular, foot support 256 may form a protective and/or supportive channel between rear cover 252, chassis 250, rear axle 244 and rear tire 220.

In some examples, foot support 256 may comprise a configuration similar to knee support 254. Further, foot support 256 may be integrated into various other vehicle portions such as chassis 250, rear cover 252, knee pads 254, or various combinations thereof. For example, foot support 256 may be integrated into a common rear chassis portion. Alternatively, foot support 256 and knee support 254 may form a common support section that provides support and/or protection for the entire leg of the rider. In this manner, foot support 256 may be utilized for supporting the foot/lower leg of the rider and protecting the rider from contact with various vehicle portions.

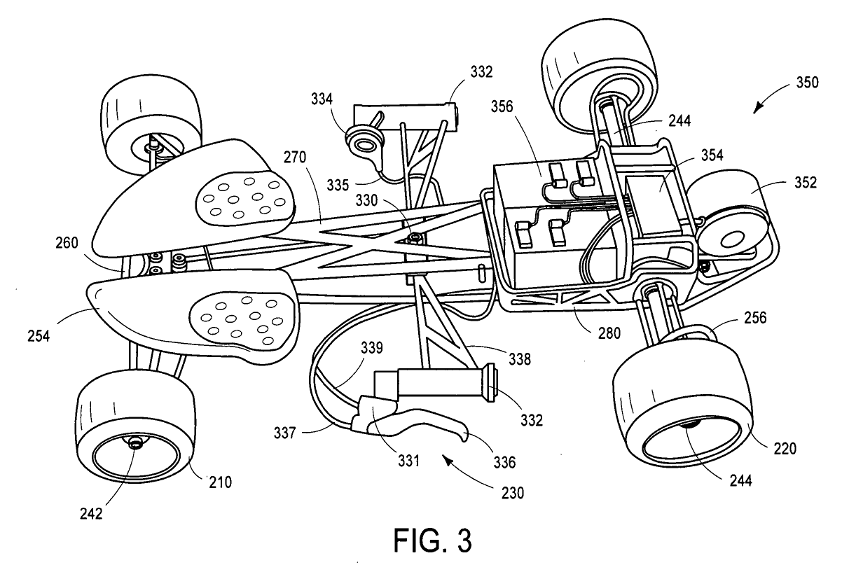

Continuing with FIG. 2, vehicle 100 is shown with handle bar 230 coupled to center chassis 270 between front wheel 210 and rear wheel 220. In particular, handle 230 is shown in between upper and lower portions of center chassis 270. FIG. 2 shows handle bar 230 coupled to center chassis 270 by a joint that allows rotation of handle bar 230 for steering vehicle 100. However, other configurations of handle bar 230 may be utilized. For example, handle bar 230 may be placed in front of knee support 254 and/or front wheels 210. In other examples, rather than using the handle bar for steering action, vehicle 100 may utilize the active body positioning of the rider to facilitate vehicle control. Alternatively, vehicle 100 may utilize a combination of rider body positioning and mechanical steering. In some examples, handle bar 230 may be in a fixed position where it is utilized for the support or stability of the rider instead of acting as a mechanism for steering the vehicle. A detailed discussion of additional example handle bar configurations is provided below with reference to FIGS. 3.

Referring now to FIG. 3, vehicle 100 is shown with rear cover 252 removed exposing propulsion system 350. FIG. 3 shows, propulsion system 350 comprising an electric motor 352 configured to a controller 354, which is powered by a battery 356. Motor 352 utilized to propel vehicle 100 is shown as a DC electric motor coupled to rear chassis 280. Controller 354, which controls the amount of power supplied to the motor by battery 356 is shown coupled to rear chassis 280 in front of motor 352. Battery 356 is shown coupled to rear chassis 280 in front of controller 354 and motor 352.

Motor 352 is shown configured in a horizontal position with a drive axle 453 (not shown) oriented parallel to rear axle 244. A variety of electric motors of various sizes and/or output may be utilized based on the desired speed or torque requirements of the vehicle. In another embodiment, an internal combustion engine may be utilized instead of an electric motor among various other propulsion systems. In some examples, motor 352 may be configured in a manner that is interchangeable with another motor having a different performance characteristic. Thus, the rider may customize the vehicle by exchanging motors or various components in order to achieve a desired vehicle performance.

Continuing with propulsion system 350, an electric battery 356 is shown comprising a plurality of batteries. Battery 356 in some examples may consist of a single battery used to power electric motor 352. In other examples, a plurality of batteries may be utilized to meet the desired power requirements of the vehicle operations. In yet other examples, battery 356 may be configured in a manner that allows the rider to customize the vehicle by adding or removing batteries in order to achieve a desired vehicle performance.

Delivery of power from battery 356 to electric motor 352 may in some configurations be facilitated by a controller 354. Controller 354 may be used to vary or restrict the contribution of battery power to electric motor 352 based on an input from the rider. In this manner, the output of motor 352 may be controlled.

A variety of configurations may be utilized for propulsion system 350. For example, the positioning of the motor, controller and battery may be of different order (i.e. with the battery located between the controller and motor). Alternatively, in some examples, the motor, controller and battery may be located in a side by side arrangement across the width of the vehicle instead of the in-line configuration shown in FIG. 3. In yet other examples, portions of the propulsion system may be integrated into one or more components of the vehicle.

Returning to handle bar 230, FIG. 3 shows an example configuration of the various portions used to control vehicle 100. Handle bar 230 is shown in FIG. 3 comprising a rigid support 338 connected to center chassis 270 by joint 330, which allows rotation of handle bar 230 relative to vehicle 100. Further, the ends of handle support 338 are shown with two hand grips 332. Hand grip 332 is shown oriented parallel to the direction of vehicle travel, however hand grip 332 may alternatively be oriented in a variety of directions. For example, hand grip 332 may be oriented parallel to handle bar 230 thus forming a straight handle bar configuration. In other configurations, hand grip 332 may be oriented vertically or at a variety of angles relative to support 338. Further, in some examples, the orientation of hand grip 332 relative to support 338 may be adjustable and therefore accommodate rider preference.

In some examples, hand grip 332 may contain a hand guard that surrounds a portion of the hand grip at a distance that allows the rider's hand to access the hand grip while simultaneously providing protection for the hand from the moving terrain surface or various other foreign objects.

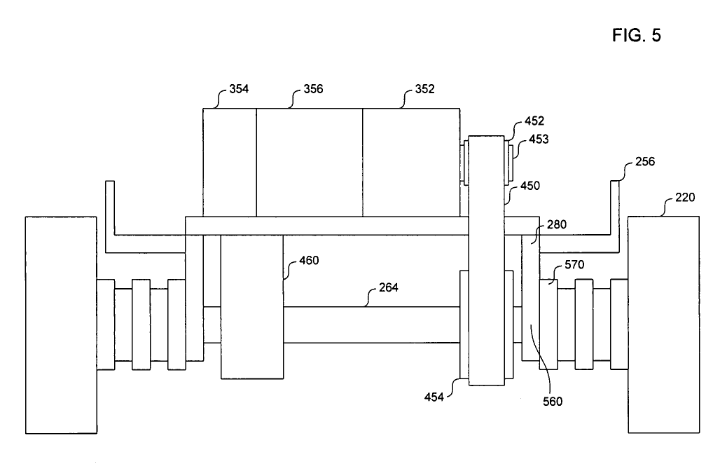

Continuing with handle bar 230, a hand brake 336 is shown coupled to left hand grip 332 communicating with rear axle 244 via brake cable 337. In this manner, an input from the rider may cause vehicle 100 to decelerate. A discussion of an example braking mechanism of rear axle 244 is provided below with reference to FIG. 5.

Further, FIG. 3 shows boost button 331 integrated into hand brake 336. Boost button 331 is configured in a manner that when activated sends a signal via cable 339 to controller 354, which in turn adds a supplemental increase of power to motor 352. In this manner, an input from the rider may cause vehicle 100 to accelerate rapidly.

A throttle 334 for controlling vehicle speed and/or direction of travel is shown mounted to right hand grip 332. Throttle 334 as shown in FIG. 3 may be activated by a thumb or finger of the rider's hand. Further, throttle 334 may in some configurations combine a forward and reverse feature. Throttle 334 is also shown communicating with controller 354 via cable 335. In some examples, throttle 334 may be a spring loaded potentiometer that controls the voltage delivered to electric motor 352 by battery 356. Further, throttle 334 may be configured in a manner that when the throttle is not operated by the rider's hand, the throttle rotates to an off position.

In this manner, the rider may actively control vehicle propulsion, braking and direction of travel through the various control implements located on handle bar 230. In some configurations, the location of these vehicle controls may be reversed. For example, the throttle may be located on the left handle and the brake lever located on the right handle. In yet another embodiment, the brake and throttle may be configured as a single control device. Further, a plurality of brake controls may provide independent front and rear braking. A further discussion of vehicle control is provided below with reference to FIGS. 5 and 6.

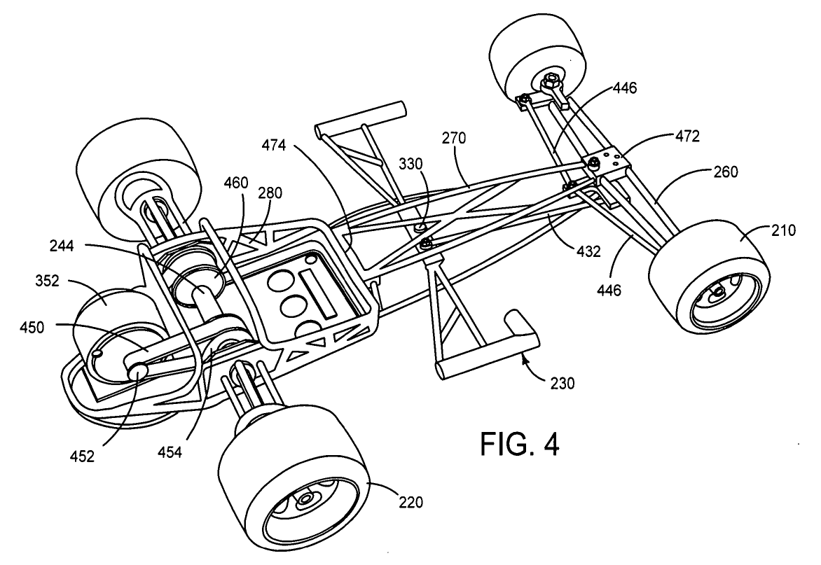

Referring now to FIG. 4, vehicle 100 is shown with front knee support 254 removed exposing front chassis 260 and various vehicle steering components. FIG. 4 also shows handle bar 230 with hand grips 332 and other controls and cables removed exposing support 338.

As shown in FIG. 4, a series of control rods may be utilized such that a turning of handle bar 230 causes proportional turning of front wheels 210 relative to vehicle 100. In particular handle bar 230 may communicate with right and left tie rods 446 via control rod 432. Tie rods 446 may in turn cause front wheels 110 to turn relative to front chassis 260 by an amount proportional to the rotation of handle bar 230. A detailed description of example the front steering components is provided below with reference to FIGS. 6.

Front chassis 260 is shown connected to center chassis 270 by interface 472, wherein a variety of methods may be used for connecting chassis sections. For example, the connection at interface 470 may be performed by removable fasteners such as by bolts as shown in FIG. 4. Alternatively, interface 470 may be a permanent connection thus making front chassis 260 and center chassis 270 a single chassis section. Further, FIG. 4 shows vehicle 100 with battery 356 and controller 354 removed exposing interface 474, which connects rear chassis 280 and center chassis 270. As shown in FIG. 4, interface 474 may be secured with bolts or a variety of other fasteners. In some examples, interface 474 may be a permanent connection thus forming a single chassis section comprising rear chassis 280 and center chassis 270. In some examples, a separate center chassis section spanning the front knee supports and rear foot supports may be utilized so that exchanging chassis sections will accommodate a variety of rider sizes. In yet other examples, the various chassis sections, knee supports, and foot supports among other portions may be adjustable to accommodate rider size or preference. Alternatively, a single chassis portion may be desired over a multi-section chassis since a single unified chassis may, in some examples, be substantially lighter, stronger, easier or less expensive to manufacture and assemble among others.

Continuing with FIG. 4, an alternate view of propulsion system 350 is shown with rear cover 252 removed. In particular, motor 352 is shown connected to rear axle 244 by drive belt 450. A motor gear 452 fixed to the axle of motor 352 causes drive belt 450 to rotate, which in turn causes rotation of axle gear 454 fixed to, axle 244. In this manner, motor 352 may propel rear wheels 220.

Referring now to FIG. 5, a rear portion of vehicle 100 is shown with rear cover 252 removed. FIG. 5 shows rear axle 244 connecting right and left rear wheels 220. Further, rear axle 244 may be connected to chassis 250 by a rear bearing 560. In this manner, rear bearing 560 may allow for the rotation of axle 260 relative to chassis 280 while simultaneously restricting translation of axle 260 relative to chassis 280. Alternatively, or in addition, the driver may rely on engine or motor braking torque to decelerate the vehicle.

Continuing with FIG. 5, rear axle 244 is shown passing through rear brake 460. Rear brake 460 as shown above with reference to FIG. 3 may be actuated by hand brake 336 via brake cable 337. In some configurations, rear brake 460 upon activation of hand brake 336 may constrict thus creating friction on the surface of axle 260 thereby slowing the rotation of rear wheels 220. In this manner, the rider may cause vehicle 100 to decelerate and/or stop.

The configuration described above may further include an axle gear 454 rigidly coupled to rear axle 244. In some configurations a drive belt 450 may connect axle gear 454 and motor gear 452 such that a rotation of motor gear 452 causes a proportional rotation of axle gear 454. Alternatively, axle gear 454 and motor gear 452 may comprise a plurality of teeth or may instead comprise a smooth surface.

In some examples, a chain may be utilized instead of a drive belt for transferring power from the motor to the rear axle. Further, in some embodiments, a plurality of axle gears and/or motor gears may be utilized to change the proportion of motor input to rear wheel output. In this manner, an input signal by the rider may cause gear switching to occur thus further controlling the performance of vehicle 100.

Continuing with FIG. 5, battery 356 and controller 354 are shown in alternative configuration situated side by side with motor 352 across the width of the vehicle. A variety of propulsion system configurations may be utilized to achieve a compact low profile arrangement based on the size and quantity of propulsion components.

Continuing with FIG. 5, foot support 256 is shown configured in the region confined by rear wheel 220, rear axle 244, and chassis 280. In some examples, foot support 256 may be combined with rear chassis 280, rear cover 252, or various other vehicle portions or combinations thereof.

In yet other examples, an axle guard 570 may be utilized where rear axle 244 is exposed. In some embodiments, axle guard 570 may comprise a hollow rubber sheath, which surrounds rear axle 264. In other embodiments, a rigid hollow tube comprising a variety of materials such as metal, plastic or rubbery may be utilized. In this manner, rear axle 244 may be separated from interaction with the rider, terrain or other foreign objects.

Referring now to FIG. 6, a two-dimensional schematic view of front chassis 260 and various steering components is shown with left knee support 254 removed. Beginning with handle bar 230, handle support 338 is shown coupled to center chassis 270 by rotary joint 330. Therefore, rotation of handle support 338 may cause translation and rotation of control rod 432 about joint 624 due to the offset of joints 330 and 624. Control rod 432 is shown connected on one end to handle support 338 by joint 624 and at the other end connected to one of two tie rods 446 via joint 622. In this manner, translation of control rod 432 causes a resulting rotation of tie rods 446 about joint 616.

Control rod 432 and tie rods 446 are shown as round solid steel rods, however a variety of shapes and materials may be utilized. Further, FIG. 6 shows tie rods 446 connected to front chassis 260 by linkage 618. Thus, tie rods 446 are permitted to rotate/translate relative to front chassis 260. Each tie rod 446 is further connected to the front wheel assembly 610 by joint 614 and front chassis 260 is connected to front wheel assembly 610 by joint 612. Thus in the configuration shown in FIG. 6, translation of tie rod 446 causes wheel assembly 610 and therefore front wheel 210 to turn relative to front chassis 260. Further, wheel assembly 610 is connected to front wheel 210 by independent front axle 242. In this manner, rotation of handle bar 230 by the rider causes a proportional rotation of front wheels 210 relative to vehicle 100. While FIG. 6 shows an example control rod configuration for steering vehicle 100, a rack and pinion steering configuration may instead be utilized.

In some embodiments, vehicle 100 described above may further include a suspension system associated with front wheels 210 and/or rear wheels 220. A suspension system may further comprise a variety of suspension components such as shocks, bushings and/or leaf springs among others associated with each of the four wheels.

The various suspension components listed above may be arranged where each wheel has its own independent suspension mechanism. For example, a small compressible rubber bushing may be utilized at joint 612 between front wheel assembly 610 and front chassis 260. In this manner, the bushing may form an independent front suspension system where an impact incurred by the front wheel may be substantially absorbed by the bushing thus reducing the effects of the impact on the vehicle chassis and rider.

Alternatively, front wheels 210 and/or rear wheels 220 may have a wishbone suspension system where the various suspension components are configured in suspension groups. In this manner, the front and rear suspension systems may be independent of each other while the front wheels share a common front suspension and the rear wheels share a common rear suspension. Further, combinations of independent and wishbone suspension configurations may be utilized together or with each separate wheel or group of wheels. In yet another example, suspension components such as bushings may be configured between chassis interfaces 472 and 474.

In some embodiments, the configuration of various suspension components may facilitate the steering of vehicle 100 by active body positioning of rider 110. For example, a rider may utilize leaning as a form of vehicle control thus causing the turning of the front and/or rear wheels in relation to the vehicle.

Referring now to FIG. 7, another embodiment of the vehicle is shown. FIG. 7 shows the vehicle configured as a single chassis with integrated knee and foot supports formed by depressions in the chassis. Further, a handlebar for steering the front wheels of the vehicle is shown as well as a rear propulsion system for propelling the vehicle.

It will be appreciated that the configurations disclosed herein are exemplary in nature, and that these specific embodiments are not to be considered in a limiting sense, because numerous variations are possible. The subject matter of the present disclosure includes all novel and nonobvious combinations and subcombinations of the various systems and configurations, and other features, functions, and/or properties disclosed herein.

The following claims particularly point out certain combinations and subcombinations regarded as novel and nonobvious. These claims may refer to “an” element or “a first” element or the equivalent thereof. Such claims should be understood to include incorporation of one or more such elements, neither requiring nor excluding two or more such elements. Other combinations and subcombinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

What is claimed is:

1. A vehicle ridden by a rider having feet and knees, comprising:
a chassis having at least one wheel, where said chassis is configured to receive at least one knee and at least one foot of the rider in a manner that permits the rider to be in a kneeling position when operating the vehicle.

2. The vehicle of claim 1, wherein the vehicle includes four wheels.

3. The vehicle of claim 1, wherein the chassis is configured to receive two knees and two feet of the rider.

4. The vehicle of claim 1, wherein the vehicle is configured with a control for steering the vehicle.

5. The vehicle of claim 4, wherein the control is a handle bar disposed substantially beneath the rider, the handle bar further disposed between a front and a rear wheel.

6. The vehicle of claim 5, wherein the handle bar is further configured with a brake and a throttle.

7. The vehicle of claim 1, wherein the vehicle is further configured with a propulsion system for propelling the vehicle.

8. The vehicle of claim 1, wherein the chassis is further configured with two knee supports, each knee support having a substantially concave depression for receiving each knee of the rider, where each knee support is disposed substantially beneath each knee of the rider.

9. The vehicle of claim 8, wherein a knee pad is coupled to an upper surface of each knee support for cushioning each knee of the rider.

10. The vehicle of claim 1, wherein the chassis is further configured with two foot supports; each foot support configured to support a foot in a substantially inverted position, where each foot support having a substantially vertical portion configured to separate the foot from a rear wheel, and a substantially horizontal portion configured to separate the foot from a rear axle connected to the rear wheel.

11. The vehicle of claims 10, wherein the two foot supports are disposed substantially closer to a rear portion of the vehicle than at least a knee support.

12. The vehicle of claim 1, wherein the vehicle is of a size and a weight that is substantially easily carried by the rider.

13. The vehicle of claim 1, wherein a field of vision of the rider when operating the vehicle is substantially unobstructed by at least one of a portion of the vehicle or a portion of the rider.

14. A children's ride-on toy, comprising:
a chassis having two knee supports;
each knee support including a depression for receiving a knee of a rider;
a control for steering the children's ride-on toy; and
a propulsion system for propelling the children's ride-on toy.

15. The children's ride-on toy of claim 14, wherein the control is a handle bar located substantially beneath the rider.

16. The children's ride-on toy of claim 14, wherein the control is located substantially in front of a front wheel.

17. The children's ride-on toy of claim 14, further including two foot supports, each foot support having a substantial depression for receiving a foot of the rider.

18. A vehicle ridden by a rider having feet and knees, comprising:
a chassis;
four wheels coupled to the chassis;
the chassis configured with two substantially concave knee supports, each knee support configured to receive a knee of the rider in a manner that permits the rider to be in a kneeling position when operating the vehicle;
the chassis further configured with two foot supports, each foot support configured to receive a foot of the rider;
an electric motor for propelling the vehicle;
at least a battery coupled to the electric motor;
a handle bar coupled to the chassis for controlling the direction of the vehicle;
a throttle for controlling an output of the electric motor; and
a brake for reducing a velocity of the vehicle.

19. The vehicle of claim 18, wherein the handle bar is disposed substantially below the chassis.

20. The vehicle of claim 18, wherein the chassis is a single portion.
